(19) United States
(12) Patent Application Publication
(10) Pub. No.: US 2010/0296099 A1
(43) Pub. Date: Nov. 25, 2010

(54) OPTICAL DEVICE

(76) Inventors: Andrew L. Van Brocklin, Corvallis, OR (US); Stephan R. Clark, Corvallis, OR (US); Matthew Brown, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/863,493

(22) PCT Filed: Feb. 6, 2008
(86) PCT No.: PCT/US2008/001640

§ 371 Date: Jul. 19, 2010

(51) Int. Cl. G01J 3/45; B23P 11/00

(52) U.S. Cl. 356/456; 29/428

(57) ABSTRACT

An optical device includes a photodetector, a Fabry-Perot interferometer and an analyzer.

### BACKGROUND

Printing devices may include a color sensing device to determine if a color has been correctly printed on a print media. Printing devices may also include a printed line detector and/or an edge of sheet detector. It may be advantageous to reduce the cost and size of these components.

### BRIEF DESCRIPTION OF THE DRAWINGS

FIG. 1 is a schematic side view of one example embodiment of a printing device including an optical device.

FIG. 2 is a schematic side view of one example embodiment of a layered structure of the optical device of FIG. 1

FIG. 3 is schematic top view of one example embodiment of the layered structure of FIG. 2.

FIGS. 4A-B are schematic top views of one example embodiment of the layered structure of FIG. 2 moved with respect to a print media.

### DETAILED DESCRIPTION OF THE DRAWINGS

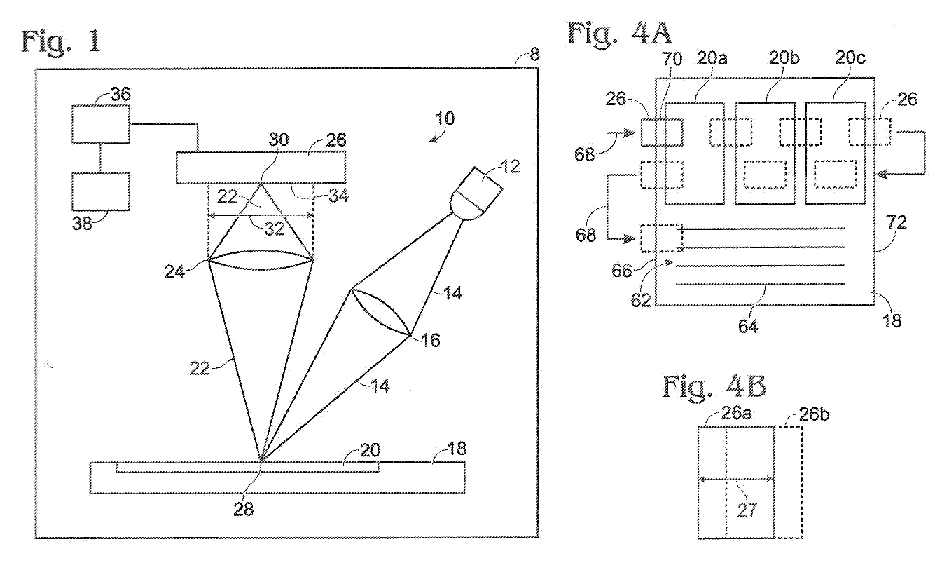

FIG. 1 is a schematic side view of one example embodiment of a printing device 8, such as a printer, in which an optical device 10 may be housed. Printer 8 may include a single optical device 10 that may function as both a color sensor and a line/edge detection device. In other embodiments optical device 10 may be housed in other types of devices where color sensing and/or line/edge detection functioning may be desired.

Device 10 may include a light source 12 that projects a source light beam 14 to an optical system 16, such as a condenser lens. Light source 12 may be any type of light source such as an incandescent light bulb, a light emitting diode (LED) or the like, for example. Accordingly, source light beam 14 may be white light, or a particular range of light wavelengths, for example. Optical system 16 may be a single lens, as shown, or multiple lenses or optical elements. Optical system 16 projects source light 14 to a sheet of print media 18 having a printed region 20 printed thereon. Printed region 20 may be a swatch of printed colored ink that may be printed by printing device 8. It may be desirable to analyze printed region 20 to determine if printing device 8 is printing a color as is desired. Moreover, it may be desirable to analyze sheet of print media 18 to determine where lines of print, if any, are located on the sheet and where an edge of sheet is positioned. Both of these functions, i.e. color sensing and line/edge detecting, can be accomplished by optical device 10 in an efficient and cost effective manner.

Source light 14 is reflected as reflected light 22 from printed region 20 of sheet of print media 18 and passes through a second optical system 24. Optical system 24 may be a single lens, as shown, or multiple lenses or optical elements. Optical system 24 projects reflected light 22 to a sensor/edge detector device 26 (which will be referred to herein as sensor 26). As shown in FIG. 1, a point of light 28 from sheet 18 may be directed to a point of light 30 on sensor 26, or may be directed by optical system 24 to cover a larger area 32 (shown in dash lines) on sensor 26. The embodiment wherein a point of light 28 from sheet 18 is reflected by optical system 24 to a point of light 30 on sensor 26 may be a particularly useful embodiment for edge detection and may be less useful for color sensing with a spatial array of detectors because the light is focused on a very small region of sensor 26. The embodiment wherein a point of light 28 from sheet 18 is reflected from optical system 24 as a large area of light 32 on sensor 26 may be a particularly useful embodiment for color sensing with a spatial arrayed color sensor and may be less useful for edge detection because the light is projected to a large region 32 of sensor 26. In the particular embodiment shown, the large projection region 32 of reflected light 22 is shown as reflected light 22 traveling toward sensor 26, and approximately perpendicular to a sensing surface 34 of sensor 26. In other embodiments, reflected light 22 may be reflected to define any sized region on sensing surface 34 as may be desired, and may fall within the range of point of light 30 and large light region 32 such that optical device 10 may perform both color sensing and line/edge detection functions simultaneously.

FIG. 2 is a schematic cross-sectional side view of one example embodiment of sensor 26 of optical device 10 of FIG. 1. In the embodiment shown, sensor 26 includes a light filter, such as a Fabry-Perot filter 40 and a light sensing device, such as a photodetector 42. Photodetector 42 may be described as a light-to-electrical transducer, such as a photodiode, a phototransistor, an avalanche-photodiode, or any other photodetector known in the art, for example. Filter 40 and photodetector 42 may be manufactured as one integral, layered structure utilizing semiconductor fabrication techniques. In particular, sensor 26 may include sensing surface 34 and an opaque layer 44 positioned therebelow. In the embodiment shown, opaque layer 44 may allow the transmission of light only through an aperture region 46 positioned directly above filter 40 and photodetector 42 and may prevent the transmission of light elsewhere into sensor 26.

Fabry-Perot filter 40 may include a fixed partially-reflective surface 48 and a movable partially-reflective surface 50 positioned above fixed reflective surface 48 and separated therefrom by a gap 52. A position of movable reflective surface 50 may be controlled, such as electrostatically deflected, for example, so that filter 40 may be tuned and/or controlled to transmit only a particular range of wavelengths of light therethrough. For example, in one embodiment filter 40 may allow the transmission of light having wavelengths only in a range of 390 to 410 nanometers (nm). In another embodiment filter 40 may allow the transmission of light having wavelengths of light only in a range of 410 to 430 nm. In another embodiment sensor 26 may include multiple filters 40 wherein each of the filters may be tuned and/or controlled to allow a unique range of wavelengths to be transmitted therethrough, such as 390 to 410 nm through one filter and 410 through 430 nm through another filter, for example.

Filter 40 may be formed directly on a top surface 54 of photodetector 42 such that filter 40 and photodetector 42 together define an integral, layered structure 56. In this embodiment the second partially-reflective surface 48 is fixed with the gap 52 distance set by a suitable dielectric spacer material 49 such as silicon dioxide. The filter 40 may be tuned by varying the spacer 49 thickness 51. Thus an array of filters can be created each with a different spacer thickness 51 thus providing a large bandwidth covered by the array as a group. For example, the bandwidth of the array of filters may be from 380-715 nm such that each corresponding photodetector 42 receives a range of light within the total range of 380-715 nm.

Photodetector 42 may include a substantially planar expanse 58 of photosensitive material. The total surface area of planar expanse 58, and correspondingly, the total surface area of filter 40, may be chosen to increase the efficiency and/or sensitivity of optical device 10, as will be described with respect to FIG. 3.

FIG. 3 is schematic top view of one example embodiment of the layered structure 56 of FIG. 2. In this example embodiment, filter 40 may include multiple, independent sub-filter regions 40a-40p, for example, wherein each of the sub-filter regions 40a-40p, may allow the transmission of light having wavelengths only in a unique range for each of the sub-filters 40a-40p. For example, filters 40a-40p may be tuned or have a fixed band width to allow passage of the following wavelengths, measured in nanometers: 40a: 390 to 410; 40b: 410 to 430; 40c: 430 to 450; 40d: 450 to 470; 40e: 470 to 490; 40f: 490 to 510; 40g: 510 to 530; 40h: 530 to 550; 40i: 550 to 570; 40j: 570 to 590; 40k: 590 to 610; 40l: 610 to 630; 40m: 630 to 650; 40n: 650 to 670; 40o: 670 to 690; and, 40p: 690 to 710. Sub-filters 40a-40p may be collectively referred to as a filter array 40. Each of the sub-filter wavelength ranges may additively encompass the entire visible spectrum wavelength range, for example, such that each portion of the visible light wavelength range is transmitted through one of sub-filters 40a-40p. In such an embodiment, sub-wavelength ranges of the entire visible wavelength range may each be detected by a sub-photodetector 42a-42p, for example, that defines a one-to-one correspondence with each of sub-filters 40a-40p.

Some of the wavelength sub-ranges of the visible wavelength range may provide a strong optical response to a photodetector, whereas other wavelength sub-ranges of the visible wavelength range may provide a weak optical response to a photodetector. Accordingly, in order to increase the efficiency and/or the sensitivity of optical device 10, each of sub-photodetector regions 42a-42p, for example, and its corresponding sub-filters 40a-40p, may be sized to provide a relatively uniform current output from each of the sub-photodetectors 42a-42p of sensor 26 when a reference color is measured. Accordingly, in the particular embodiment shown in FIG. 3, sub-filter 40a and sub-photodetector 42a each have a large cross sectional light receiving area 60a. Sub-filter 40b and sub-photodetector 42b each have a large cross sectional light receiving area 60b that is approximately ¾^{th} the size of area 60a. Sub-filter 40c and sub-photodetector 42c each have a cross sectional light receiving area 60c that is approximately ¼th the size of area 60a. Sub-filter 40e and sub-photodetector 42e each have a cross sectional light receiving area 60e that is approximately ⅙th the size of area 60a. In general, the cross sectional size 60 of a sub-photodetector 42 may be inversely proportion to an intensity of a wavelength range of light for which its corresponding interferometer 40 is tuned, such that each of the sub-photodetectors 42 generates a substantially uniform current value to analyzer 36 when a reference color is measured. The reference color may be chosen to allow maximizing of the signal to noise ratio of all the photodetectors when measuring non-reference colors. For a fixed system it may not be possible to make the signal to noise ratio constant for all the arrayed sensors for all colors that may be measured. Thus it may be desirable to make the system as good as possible for a large range of colors. For example, the reference color may be a white sample or another suitable neutral color. This may remove any bias toward any one specific color, giving the system more range for accurate color measurements.

In other example embodiment, the visible wavelength range may be sectioned into a number of sections different from sixteen sections 40a-40p, and each of the sizes of light receiving areas 60 of the photodetectors 42 and filters 40 may be sized differently than shown, as desired for a particular application.

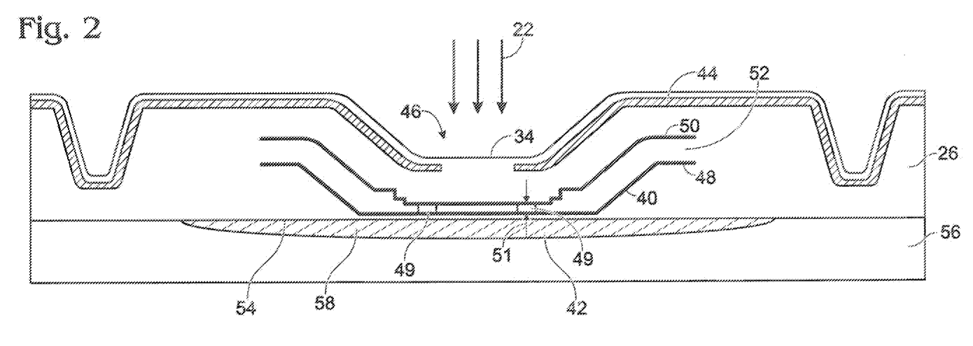

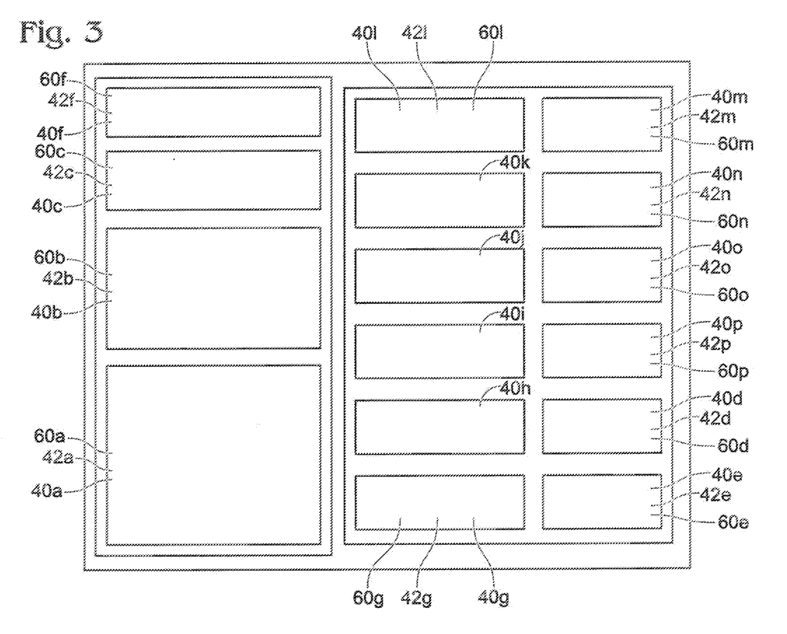

Accordingly, referring to FIGS. 1-4B, in this manner, the varied size of the sub-photodetector regions 42a-42p may allow an optimized signal to noise ratio for the output of each of the sub-photodetector regions 42a-42p of sensor 26 when measuring a color of interest. Due to the relatively uniform current output from each of the sub-photodetector regions 42a-42p, an analyzer 36 may provide an efficient and accurate reading of a color of printed region 20 and/or an accurate positional determination of an edge 62 of a line 64 of printed ink or an edge 66 of a sheet of print media 18, as will be further described with respect to FIG. 4.

FIG. 4A is a schematic top view of one example embodiment of sensor 26 of FIG. 2 moved with respect to a sheet of print media 18. Sheet 18 may include multiple color printed regions 20a, 20b and 20c for example, that may each include the same color printed ink, such as green, for example, or may each include a different color printed ink, such as region 20a having green ink, region 20b having red ink and region 20c having blue ink, for example, printed thereon.

As sensor 26 is moved with respect to sheet 18, as shown by path 68, such as by a motor associated with analyzer 36, sensor 26 is moved over the colored test swatch regions 20a, 20b and 20c, and then back again over the three swatch regions, and then over the edge 62 of a line 64 of printed ink, for example. In the embodiment shown, path 68 is a snake-like pattern wherein sensor 26 is moved back and forth across sheet 18. Path 68 indicates sensor measurements (dash lined positions of sensor 26) taken in a non-overlapping manner for ease of illustration. However, in practice, path 68 may be a pattern wherein sensor 26 is moved back and forth across sheet 18 and sensor measurements are taken in an overlapping manner.

As shown in FIG. 4B, one type of overlap may include sensor measurements being taken when sensor 26 is moved horizontally in a single direction from a first position 26a to a second position 26b (shown in dash lines) by a distance less than a width 27 of the sensor 26. In this embodiment the regions of sequential sensor measurements may overlap one another such that the left half of second measurement region 26b may overlap the right half of the adjacent, previous measurement region 26a.

Another type of overlap may include sensor measurements taken along one horizontal pass and then additional sensor measurements taken along a second horizontal pass that somewhat overlaps with the previous horizontal pass. In this embodiment the top regions of sensor measurements may overlap with the bottom regions of sensor measurements from the pass above. Taking many such partially overlapping measurements may provide a large number of sensor measurements for analyzer 36 to average, thereby resulting in an accurate color measurement of printed region 20. In one particular example, sensor 26 may be moved along path 68 in one millimeter (1 mm) increments so as to allow measurement of a large number of regions of sheet 18.

Referring again to FIG. 4A, in the embodiment wherein each of color regions 20a-20c are the same color printed ink, sensor 26 may be moved with respect to sheet 18 into several different positions over each of regions 20a-20c, for example. At each position a sensor reading is taken by each of sub-photodetector sensing regions 42a-42p. After movement of sensor 26 across a portion of sheet 18, each of the sub-photodetector sensing regions 42a-42p will have detected several sensor readings. i.e., several light measurements, at different positions on sheet 18. The readings are then digitally averaged by software 38 (FIG. 1) of analyzer 36 (FIG. 1). The digitally calculated average of the sensor readings may then be compared and matched to known color standards data stored within analyzer 36 to provide an efficient and accurate calculated color determination of printed color region 20.

The measurements from individual sensor elements 42a-42p may be time shifted and averaged such that measurements for a particular colored area are all derived from sensor outputs while each of the sensors are over the particular colored area. For example: light from a particular colored area 20a may be imaged onto sensor 20a for a time period (t), given a colored area x direction imaged extent w with an imaged linear velocity (V_{S1}). The x direction is the direction of sensor travel over the paper. This follows the relationship t=w/V_{S1}. The extent of the image of the colored area on the sensor and its linear velocity may vary according to the transverse magnification of the optical design (M_{T}). Given a paper to linear velocity (V_{SP}), if M_{T}=1, then the paper to sensor linear velocity V_{SP} will be the same as the linear velocity of the image of the paper to the sensor (v). If M_{T}=0.5, then the linear velocity of the image of the paper on the sensor surface will be V_{S1}=M_{T}*V_{SP}, or half of the paper to sensor linear velocity. What this implies is that the image of a colored area on a particular sensor will be present during a different but usually overlapping time period. The time periods in which light from a particular area will be on the sensor will vary depending on the width of the image of the colored area and the width of the sensor. For the shown linear movement, light from a colored area will be placed on sensor 20a first, then 20b, then 20c. An average of the measured light collected while the sensor is collecting within the colored region is obtained from each of the sensors. These averages are collected at different times. But they are applied to the color measurement algorithm as if they come from the same section of paper.

A total surface area 70 of sensor 26, which may include sub-filter regions 40a-40p for example, may be only a small portion of a total surface area 72 of a sheet of print media 18 so that multiple light intensity measurements may be taken across sheet of print media 18 to provide precise digital averaging of the sensor measurements.

Still referring to FIG. 4A, in one embodiment, simultaneous to color determination as described above, as sensor 26 is moved with respect to sheet 18 along path 68, sensor 26 may be moved over edge 62 of printed ink 64, or may be moved over edge 66 of sheet 18 to determine the edge of a printed ink region or the edge of a sheet of the print media 18. Movement over such edge regions 62 and/or 66 may provide a measurable change in light intensity received by photodetector 42, or received by ones of sub-photodetectors 42a-42p, between sequential, adjacent sensor measurements. Detection of this change in light intensity may be interpreted by analyzer 36 as a position of edge 62 of printed ink 64 or a position of an edge 66 of sheet 18. Accordingly, sensor 26 may simultaneously perform both color sensing and line/edge detection functions. Moreover, such color sensing and line/edge detection functions may be conducted by a single optical device structure, thereby reducing the cost and size of printer 8.

Referring again to FIG. 1, when reflected light 22 is focused to a point of light 30, very small changes in position of sensor 26 with respect to sheet 18 will allow a precise determination of a position of edge 62 of printed ink 64 or a position of an edge 66 of sheet 18, but may not facilitate a precise determination of a color of printed region 20. In contrast, when reflected light 22 is projected to sensor 26 across a large area of light 32, sensor 26 may not facilitate a precise determination of a position of edge 62 of printed ink 64 or a position of an edge 66 of sheet 18, but may facilitate a precise determination of a color of printed region 20. In an embodiment wherein it may be desirable to utilize optical device 10 to make both color and edge/line position determinations, optical system 24 may be focused so that reflected light 22 defines an area of light on sensing surface 34 within a range of the area of point of light 30 and the large area of light 32. In another embodiment, optical system 24 may be adjustably focusable by a controller, such as analyzer 36, during use of printer 8 so that a single optical device 10 may be utilized to facilitate a precise determination of a position of edge 62 of printed ink 64 or a position of an edge 66 of sheet 18, and a precise determination of a color of printed region 20.

Other variations and modifications of the concepts described herein may be utilized and fall within the scope of the claims below.

We claim:

1. An optical device (10), comprising:
a photodetector (42);
a Fabry-Perot interferometer (40), wherein said interferometer and said photodetector together define an integral, layered structure (56); and
an analyzer (36) that analyzes multiple sequential image samples each traveling along a light path (22) through said interferometer and to said photodetector to determine a color measurement of said multiple sequential image samples and to determine a change in light intensity between different ones of said multiple sequential light samples.

2. The device (10) of claim 1 wherein said photodetector (42) comprises a silicon photodetector.

3. The device (10) of claim 1 wherein said analyzer (36) determines an average color of said multiple sequential light samples by averaging a color intensity of individual ones of said multiple sequential light samples.

4. The device (10) of claim 1 further comprising a motor (36) that moves said device relative to a print media such that said multiple sequential light samples are each received from a unique location on said print media.

5. The device (10) of claim 1 wherein said device comprises:
a plurality of photodetectors (42);
a plurality of Fabry-Perot interferometers (40), wherein each of said plurality of interferometers and a corresponding one of said plurality of said photodetectors together define an integral, layered structure; and
said analyzer (36) analyzing multiple sequential light samples traveling along each of a plurality of light paths through corresponding ones of said interferometers and corresponding photodetectors to determine a color measurement of said multiple sequential light samples for each of said multiple interferometers and corresponding photodetectors, and to determine a change in color between different ones of said multiple sequential light samples.

6. The device (10) of claim 5 wherein each of said plurality of interferometers (40) is tuned to transmit a unique wavelength range of light.

7. The device (10) of claim 6 wherein each of said plurality of photodetectors (42) defines a size of a light receiving region that is inversely proportion to an intensity of a wavelength range of light for which a corresponding interferometer is tuned, such that each of said plurality of photodetectors generates a substantially uniform current value when a reference color is measured.

8. The device (10) of claim 1 further comprising a light source (12) that projects light to a lens (16), said lens projecting said light to a print media (18), said device further comprising a second lens (24) that projects a light reflected from said print media to said interferometer.

9. The device (10) of claim 8 wherein said second lens (24) focuses said light reflected from said print media to said interferometer within a range having a cross sectional area (32) extending from a point of focus (30) to a full range of light defined by a non-converging and a non-diverging light projected from said second lens.

10. A method of making an optical device (10), comprising:
forming a stacked layer structure (56) including a Fabry-Perot interferometer (40) and a photodetector (42); and
connecting said photodetector to an analyzer (36) that averages multiple light intensity measurements to determine a color of light received by said photodetector through said interferometer and to determine a position of a change of light intensity received by said photodetector through said interferometer, wherein said change of light intensity indicates one of an edge of a line of printed matter (62) and an edge of a print media (66).

11. The method of claim 10 wherein forming said stacked layer structure (56) including a Fabry-Perot interferometer (40) and a photodetector (42) includes forming a plurality of Fabry-Perot interferometers and a plurality of photodetectors each corresponding to one of said interferometers.

12. The method of claim 10 wherein said photodetector (42) is a silicon photodetector and wherein said interferometer (40) is formed directly on a top surface (54) of said photodetector.

13. The method of claim 10 wherein said analyzer (36) comprises a microprocessor device including software that digitally averages said multiple light intensity measurements.

14. The method of claim 13 wherein said microprocessor device (36) further comprises stored data representing a known color quantity, and wherein said analyzer compares an averaged light intensity measurement with said stored data.

15. The method of claim 13 wherein said optical device (10) further comprises an optical element (24), and wherein said microprocessor device adjusts a focus of said optical element by altering a position of said optical element to provide optical averaging of one area of a colored area's reflected light simultaneously onto multiple sub-photodetectors (42a) of said photodetector (42).

16. A method of using an optical device (10), comprising:
filtering through a Fabry-Perot filter (40) multiple reflected light measurements from corresponding multiple portions of a printed color region (20), said portions each being smaller than a total size of said printed color region;
receiving at a photodetector (42) said multiple reflected light measurements filtered through said filter;
digitally averaging said multiple reflected light measurements received though said filter to determine a color of said printer color region.

17. The method of claim 16 further comprising determining a position of a substantial change in light intensity between sequential ones of said multiple reflected light measurements to determine one of a position of an edge of a line of printed matter (62) and a position of an edge of a print media (66) having said printed color region printed thereon.

18. The method of claim 16 wherein said optical device (10) includes multiple Fabry-Perot filters (40a) each transmitting only a unique wavelength range and wherein each filter (40a) filters multiple reflected light measurements from corresponding multiple portions of said printed color region.

19. The method of claim 18 wherein each filter (40a) is associated with a corresponding photodetector (42a), and wherein each of said photodetectors defines a size of a light receiving region (60a) that is inversely proportion to an intensity of a wavelength range of light that its corresponding filter transmits, such that each of said photodetectors generates a substantially uniform current value when measuring a reference color.

20. The method of claim 16 further comprising causing relative movement between said optical device (10) and said print media (18) such that said multiple reflected light measurements define a path along said print media.

21. The method of claim 20 wherein portions of said multiple reflected light measurements overlap one another.
